(19) United States
(12) Patent Application Publication
(10) Pub. No.: US 2026/0116136 A1
(43) Pub. Date: Apr. 30, 2026

(54) METHOD FOR ALIGNING A LEVEL POSITION OF A STATIONARY INCLINED MOTOR VEHICLE IN THE HORIZONTAL DIRECTION

(71) Applicant: AUMOVIO Germany GmbH, Frankfurt am Main (DE)

(72) Inventors: Hermann Hoinkhaus, Burgwedel (DE); Frank Wolters, Süpplingenburg (DE); Stefan Bunge-Goldmann, Hannover (DE)

(73) Assignee: AUMOVIO Germany GmbH, Frankfurt am Main (DE)

(21) Appl. No.: 19/369,215

(22) Filed: Oct. 25, 2025

(30) Foreign Application Priority Data
Oct. 25, 2024 (DE) 10 2024 210 327.6

(51) Int. Cl. B60G 17/017; B60G 17/015; B60G 17/019

(52) U.S. Cl. CPC B60G 17/017; B60G 17/0155; B60G 17/01908; B60G 2400/0511; B60G 2400/0512; B60G 2400/252; B60G 2400/954

(57) ABSTRACT

A method for controlling the level position of a stationary, inclined vehicle using an actively adjustable chassis comprises a number of spring-damper units with associated height sensors. The spring-damper units are arranged between a vehicle body and an associated wheel of the vehicle. A respective actual height value of the vehicle body relative to the corresponding wheels is measured. The height sensors transmit the respective height value to an electronic control and regulation device. The electronic control and regulation device receives a roll and/or pitch angle of the vehicle body from a position sensor. For each spring-damper unit a target height value for aligning the vehicle in a horizontal level position is calculated by adding an inclined position correction value dependent on the roll and/or pitch angle to the respective actual height value and subtracting an average height value from the actual height values of all spring-damper units.

### TECHNICAL FIELD

The embodiments relate to a method for regulating a level position of a stationary inclined motor vehicle by means of an actively adjustable chassis.

### BACKGROUND

There are a wide variety of methods for level position control of a motor vehicle with an actively adjustable chassis. Essentially, it is a matter of setting the motor vehicle to a desired level and maintaining it. As a result of the detection of the height of the motor vehicle with respect to the roadway by means of an appropriate sensor system, the level position of the motor vehicle is adapted according to the situation. For example, after loading the motor vehicle a level adjustment is carried out or the motor vehicle is lowered during travel in order to save fuel.

Such a level position regulation can be carried out, for example by means of an air suspension system as part of the actively adjustable chassis. For example, electronically controllable air suspension systems are being increasingly used for level position regulation of passenger cars. The main components of an air suspension system are air springs filled with compressed air which provide springing for the vehicle body, and an air supply device which provides the compressed air. These two components are connected to one another via pneumatic lines. Moreover, a wide variety of sensors, such as height and pressure sensors, and an electronic control and regulation device are provided. A wide variety of electromagnetic switching valves which are activated by the control and regulation device are arranged in the pneumatic lines. It goes without saying that the sensors and the switching valves are connected to the control and regulation device via electrical lines.

An air suspension system allows active changes in the height/level of the vehicle body relative to the road surface by opening and closing certain switching valves. Depending on requirements, the air springs are filled with compressed air or emptied in order to adjust the vehicle level. Height refers to the distance of the vehicle body (bodywork) from the road surface. Since the distance of the vehicle body on the axles of the motor vehicle with respect to the roadway may vary, reference is also made to a level position.

In order to determine the current level position of the motor vehicle, a chassis sensor is generally used which detects the spring travel of the wheel as an unsprung mass in relation to the vehicle body as a sprung mass. Such a chassis sensor is fitted in the region of the wheel suspension or of the spring-damper unit of the motor vehicle in order to determine the spring travel of the wheel relative to the vehicle body. Such suspension sensors are also referred to as height sensor, vertical sensor, level sensor or spring travel sensor. The spring travel sensor transmits its signal to the electronic control and regulation device of the motor vehicle, in which the signal is processed further.

In the case of relatively large vehicles, such as mobile homes and the like, which are equipped with an air suspension system, there is a desire to align the stationary vehicle in the horizontal direction when it is standing on an uneven or inclined ground. Such an inclined position of the vehicle is determined, for example, with a position sensor which is attached to the vehicle body.

Thus, U.S. Pat. No. 7,104,547 B2 discloses a method for orienting a stationary vehicle toward an artificial horizon, in which method the vehicle needs to be positioned as an imaginary reference plane in an alignment approximate to a predetermined reference point, wherein the vehicle comprises a fluid suspension system having a plurality of fluid suspension elements and a pressurized fluid source, the pressurized fluid source being fluidically connected to the fluid suspension elements and comprises a valve control device and an electronic control unit, wherein an alignment sensor is supported on the chassis, which alignment sensor outputs the alignment of the chassis as a signal to the electronic control unit, a comparison of the signal from the alignment sensor with the predetermined reference point is performed, and it is then determined which fluid suspension element is in the highest position, and it is checked whether this highest position can be lowered sufficiently to bring the chassis to an approximate alignment on the predetermined reference point, in order then to allow fluid outlet from the fluid suspension elements by selective actuation of the valve control device until the signal from the alignment sensor approximately corresponds to the alignment data of the imaginary reference plane.

However, this method has iterative adjustment of the fluid suspension elements until the chassis is aligned with the horizon. This process can delay alignment in air supply systems with system-inherent component protection.

Furthermore, in the case of acceleration sensors which are frequently used as position sensors, the accuracy is often not sufficient. Such acceleration sensors provide the lateral and longitudinal acceleration acting on the vehicle body. For example, the increment 0.025 m/s² corresponds to a slope of 0.146°, which, in the case of a vehicle geometry with a wheelbase of 3000 mm and a track width of 1800 mm, corresponds already to a right-to-left deviation of 4.59 mm and front-to-rear of 7.65 mm. Such inaccuracies of greater than 5 mm cannot be accepted in modern air suspension systems. This is because there is also the risk that the height of an air spring to be set will lie above the permissible limit.

### SUMMARY

It is therefore an object to provide a method for controlling a level position of a stationary inclined motor vehicle, which permits faster alignment to the desired level position.

Accordingly, a method is provided for controlling a level position of a stationary inclined motor vehicle by means of an actively adjustable chassis, wherein the chassis comprises a number of spring-damper units with assigned height sensors, wherein the respective spring-damper units are arranged between a vehicle body of the motor vehicle and an assigned wheel of the motor vehicle, wherein a respective actual height value of the vehicle body is measured by the height sensors relative to the corresponding wheels, wherein the height sensors communicate the respective height value to an electronic control and regulation device of the motor vehicle, wherein the electronic control and regulation device receives a roll angle and/or pitch angle of the vehicle body from a position sensor, wherein, for each spring-damper unit, a target height value for the alignment of the motor vehicle into a horizontal level position is calculated from the fact that the respective actual height value, an inclined position correction value dependent on the roll angle and/or pitch angle is added and an average height value is subtracted from the actual height values of all spring-damper units.

The exemplary method is thus characterized in that the target values required for the alignment of the motor vehicle into a horizontal are corrected for the spring-damper unit by inclined position correction value, which depends on the present roll and/or pitch angle of the motor vehicle, and by an average height value, which is determined from the actual height values of all spring-damper units. In this way, more accurate target values are determined which compensate for the inaccuracy of the position sensor. With such precise values, regulation can be carried out with increased functionality and a better user experience.

The inclined position correction value may be determined in dependence on the vehicle-specific wheelbase and/or in dependence on the vehicle-specific track width. Taking into account the vehicle-specific properties, such as wheelbase and track width, the inclined position correction value dependent on the roll angle and/or pitch angle can be determined in such a way that as accurate as possible a statement can be made about the actual inclined position of the vehicle, adjusted considering the inaccuracies of the position sensor.

In order to compensate for the spring-stiffness-induced inclination of the suspension on a slope, according to the example the inclined position correction value is determined, which depends on the pitch angle and/or roll angle of the position sensor. This superposition of the spring stiffness-induced inclination of the suspension in addition to the pitch angle and roll angle is calculated as follows. For the pitch angle Ax=g*sin (gradient (track width)+inclination of the suspension (track width) and for the roll angle Ay=g+sin (gradient (wheelbase)+inclination of the suspension (wheelbase).

By inputting the vehicle data, such as wheelbase, track width and the entire adjustment travel of the spring-damper units, an inclined position correction value can be calculated for the pitch and roll movement of the vehicle. The inclined position correction value allows an adequate target height value to be calculated for the spring-damper units in order to align the vehicle body on a slope according to a horizontal plane.

The formula for calculating the target height values is as follows: targetlevel_hor=actual level+inclined position correction value−mean value (actual level). This formula applies to any spring-damper unit.

In certain inclined positions, the adjustment range can be utilized to the maximum by calculating further corrections from the maximum and minimum target height values, which make the best possible use of the adjustment range. The formula for this is as follows: targetlevel_hor_correction=targetlevel_hor−(targetlevel_hor_max+targetlevel_hor_min)/2. This formula also applies to every spring-damper unit.

Thus, on the basis of available measurement variables, such as height values at all four vehicle corners, transverse and longitudinal acceleration and suspension strut pressures, the inclination of the plane is determined and converted to the four vehicle corners. This then always includes the slope of the underlying surface added to the slope of the vehicle body caused by the current horizontal accelerations. This is superposed by any unevenness of the ground if a wheel is in a depression or on an elevation.

The amount by which the vehicle must be corrected at the respective vehicle corners therefore results from this inclination calculation. Here, for plausibility checking, e.g. the correction characteristic curves of the level regulator stored in the electronic control and regulation device are used.

Through the determination of a mean value from the actual height values, height influences of the underlying surface are compensated, which may limit the adjustment since due to the required correction it could lie outside the adjustment range. In order to circumvent this, the mean value is determined from the actual height values and is calculated in such a way that the initial leveling level is close to the normal level or at the center of the adjustment range. Based on this initial leveling level, the greatest possible adjustment range is then available. Moreover, the effects of parallel stiffnesses of the chassis suspension are minimized.

If the adjustment range of one vehicle corner is then exceeded only to a minimum extent by the calculated target level, and at the same time the adjustment range at the other corners is not fully exploited, a second correction once again adapts the initial leveling level such that the vehicle corner situated slightly above the adjustment range returns into the adjustment range.

By relating the initial leveling level to the normal level, it is furthermore ensured that the existing target air quantity of the vehicle is sufficient, since during the leveling it is also possible to approach suspension strut positions beyond the adjustment range used in normal operation. For example, in normal operation, level positions between ±25 mm are used, but the total adjustment travel is ±50 mm. The remaining spring travel that has to be kept available in normal operation is of lesser importance when using the levelling function, so that a larger adjustment travel can be used.

The regulation strategy to be used for adjustment to target height, including the optimized adjustment (principle, sequence, regulation speed, etc.) is derived from the corresponding adjustment requirement in order to obtain a quick and good regulation result. In this case, a start is generally made with the largest regulation difference. Thereafter, while maintaining the regulating direction, the next higher regulating difference is adjusted until there is no longer a regulating requirement for this regulating direction. Thereafter, the direction of regulation is changed and the procedure is analogous, starting with the greatest difference. This can be repeated if necessary after checking the regulation result. Since this concept for leveling is incorporated in the standard level regulator, all devices for checking the plausibility of the system functions and for protecting the system are automatically also available. These include, inter alia, various pressure monitoring operations and the “regulation position cannot be set” check, which would have to be implemented separately in the case of an individual implementation of the function.

The actively adjustable chassis may be designed as a pneumatic suspension system. In the air suspension system, compressed air is fed into the air springs or let out of them in order to bring about a change in the level position. The air suspension system may work in the closed air supply mode, in which compressed air can be displaced between the air springs and a pressure accumulator.

### DESCRIPTION OF THE DRAWINGS

Further embodiments will be apparent from the following description of an exemplary embodiment based on the FIGURE.

FIG. 1 shows a stationary motor vehicle 1 which is standing on an inclined underlying surface 9 and therefore its vehicle body 2 is inclined with respect to a horizontal (which is indicated by the arrow at X). The vehicle body 2 as a sprung mass is cushioned in relation to the respective wheels 4 as unsprung masses by a number of spring-damper units 3 (preferably air springs or air spring dampers). The spring-damper units 3 of the front and rear axles are assigned respective height sensors 5. It is self-evident that two spring-damper units 3 with respective height sensors 5 are provided on each axle of motor vehicle 1.

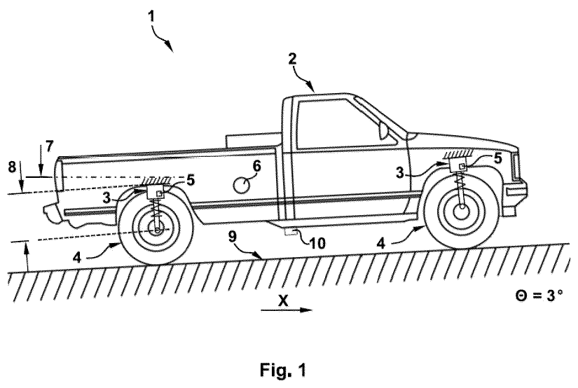

An actual level position 8 of the vehicle body 2 with respect to wheels 4 is measured by way of height sensors 5. The actual level position 8 may differ from a target level position 7. The level position in itself is the relative distance between the upper attachment of the spring-damper unit 3 to the vehicle body 2 and the lower fastening of the spring-damper unit 3 to the wheel carrier or wheel 4. Thus, the relative distance between the vehicle body 2 as the sprung mass and the wheel 4 as the unsprung mass is measured by the height sensor 5. The measurement signals from height sensors 5 are continuously fed to an electronic control and regulation device 6 of motor vehicle 1 and processed there. There, the measurement signals are generally filtered in order to be able to be processed further as smoothed height values, and are used for the target/actual regulation of the level position of motor vehicle 1. The measurement signals from height sensors 5 thus provide information about the current level of the motor vehicle 1. In addition, the electronic control and regulation device 6 receives the signals of a position sensor 10 which indicate the roll angle and/or pitch angle of the vehicle body 2. The position sensor 10 used may be an acceleration sensor which measures the current longitudinal and transverse acceleration acting on the vehicle body. Thus, the illustrated pitch angle θ is, for example 3°. A tilted position of the vehicle with a roll angle φ of e.g. also 3° is also comprised by the method.

Due to the inaccuracy, e.g. in the resolution of the acceleration sensor, this can lead to a height deviation from the actual inclined position of the vehicle body 2 as seen over the dimensions of the vehicle body 2 (track width and wheelbase). Furthermore, the vehicle body 2 is not always oriented parallel to the slope of the underlying ground 8, but rather the vehicle body 2 is additionally inclined in a manner dependent on the spring stiffness of the chassis. That is to say that the vehicle body 2 is not oriented parallel to the underlying ground 8 of the slope, but is additionally inclined in the longitudinal and/or transverse direction.

These deviations are not taken into account by a method which relies solely on the values of the position sensor to calculate the target height values for the spring-damper units. The exemplary method which takes into account an inclined position correction value and the average value of all actual height values for calculating the target height values better reflects the actual position of the motor vehicle body.

1. A method for controlling the level position of a stationary, inclined motor vehicle with an actively adjustable chassis comprising:
measuring a respective actual height value of a vehicle body relative an associated wheel of the motor vehicle with height sensors, wherein the height sensors are associated with a number of spring-damper units arranged between the vehicle body of the motor vehicle;
transmitting the respective height value from the height sensors to an electronic control and regulation device of the motor vehicle;
receiving with the electronic control and regulation device a roll and/or pitch angle of the vehicle body from a position sensor; and
calculating for each spring-damper unit a target height value for aligning the motor vehicle in a horizontal level position by adding an inclined position correction value dependent on the roll and/or pitch angle to the respective actual height value and subtracting an average height value from the actual height values of all spring-damper units.

2. The method according to claim 1, further comprising determining the inclined position correction value depending on a vehicle-specific wheelbase.

3. The method according to claim 1, further comprising determining the inclined position correction value depending on a vehicle-specific track width.

4. The method according to claim 1, further comprising calculating a further corrected target height value for each spring-damper unit from the target height value for each spring-damper unit minus half of the sum of a maximum target height value and a minimum target height value.

5. The method according to claim 1, wherein said method is carried out on request for the horizontal alignment of the motor vehicle.

6. The method according to claim 1, further comprising checking in the electronic control and regulation device that the determined target height values for each spring-damper unit whether the determined target height values can be attained by the respective spring-damper unit.
